(19) United States
(12) Patent Application Publication
(10) Pub. No.: US 2026/0012121 A1
(43) Pub. Date: Jan. 8, 2026

(54) GROUND SCREW CONNECTION BRACKET

(71) Applicant: APA SOLAR, LLC, Ridgeville Corners, OH (US)

(72) Inventors: Joseph Von Deylen, Whitehouse, OH (US); Josh Von Deylen, Bryan, OH (US)

(21) Appl. No.: 19/262,455

(22) Filed: Jul. 8, 2025

Related U.S. Application Data
(60) Provisional application No. 63/668,469, filed on Jul. 8, 2024.

(51) Int. Cl. H02S 20/10; H02S 20/30

(52) U.S. Cl. CPC H02S 20/10; H02S 20/30

(57) ABSTRACT

A ground screw connection bracket for securing a structural member to a ground screw in a solar panel foundation system includes an closed end having a generally circular configuration with an opening that partially encircles a shaft of the ground screw. A pair of arms extend from opposing sides of the opening to define a generally U-shaped configuration, with each arm including apertures that align with corresponding apertures on the opposing arm. The arms can be drawn together to create a clamping force that causes the closed end to tighten around the ground screw shaft. The bracket eliminates the need for threaded connections welded to the ground screw and allows for adjustable positioning along the shaft.

### CROSS-REFERENCE TO RELATED APPLICATIONS

This application claims the benefit of U.S. Provisional Application No. 63/668,469, filed on Jul. 8, 2024. The entire disclosure of the above application is incorporated herein by reference.

### FIELD

The present technology relates to solar panel foundations and, more particularly, to a connection bracket for a ground screw used in a solar panel foundation.

### INTRODUCTION

This section provides background information related to the present disclosure which is not necessarily prior art.

Installing solar panels using solar panel foundation systems presents significant challenges on sites with rough terrain having loose or frozen soil, or uneven topography. A-frame solar panel foundations make installation on such sites more economical, but the underlying foundation technology creates substantial limitations for installers and project developers. Solar panel foundations often employ a single driven pile to reach a depth necessary to support the load of a solar panel system. Foundations with single driven piles rely on skin friction, and a deeper embedment to combat rough terrain. Once installed, making adjustments to the foundation system to accommodate changes in terrain or to correct miscalculations during initial installation is often impractical or impossible without significant additional work. This rigidity can lead to increased costs and extended project timelines, particularly in retrofitting or expanding existing solar farms.

The use of ground screws can provide some relief by offering easier installation and better adaptability to various soil conditions compared to other solar installation piles. However, even ground screw systems have limitations, particularly regarding the connection of the ground screws to the solar panel foundation frames. Ground screw systems can use brackets that need to be welded or otherwise permanently affixed to the screws, which limits adjustability and increases the complexity of both installation and any future modifications. The welding process requires skilled labor and creates permanent connections that cannot be easily repositioned or adjusted after installation. These welded connections also require threaded connections to be welded to the ground screws, adding complexity and potential failure points to the system.

The reliance on welded connections creates several operational challenges for solar installation projects. The welding process requires extensive site preparation and skilled technicians, increasing both labor costs and project timelines. The permanent nature of welded connections means that any miscalculations during initial installation or changes in project requirements can necessitate complete rework of foundation elements. Furthermore, the inability to make adjustments after installation limits the system's adaptability to varying terrain conditions or evolving project specifications.

These limitations in existing ground screw connection systems create barriers to efficient solar panel installation, particularly in challenging environments where flexibility and adjustability would provide significant advantages. The complexity of welded connections and the lack of adjustability in existing systems can increase the overall environmental impact of solar panel installations by requiring more extensive site preparation and potentially generating waste from rework or modifications.

Accordingly, there is a continuing need for a ground screw connection bracket that is not only easier and quicker to install but also provides greater flexibility and adaptability to accommodate diverse installation environments and requirements, while reducing the need for extensive site preparation, minimizing the reliance on skilled labor for on-site adjustments, and providing a sustainable solution that decreases the overall environmental impact of solar panel installations.

### SUMMARY

In concordance with the instant disclosure, a ground screw connection bracket that is not only easier and quicker to install but also provides greater flexibility and adaptability to accommodate diverse installation environments and requirements has surprisingly been discovered.

In one embodiment, a ground screw connection bracket can provide a versatile and adjustable connection system for solar panel foundations that eliminates the need for welded threaded connections. The bracket can include a closed end having an opening that can be configured to partially surround a shaft of a ground screw, enabling the bracket to conform to the cylindrical shape of the ground screw for optimal force distribution. A pair of arms can extend from opposing sides of the opening in the closed end to define a generally U-shaped configuration, with each arm including a plurality of apertures formed therethrough that can be configured to align with corresponding apertures on the opposing arm. The arms can be configured to be drawn together to create a clamping force that can cause the closed end to tighten around the shaft of the ground screw, providing a secure and adjustable connection that can be positioned at any point along the shaft.

In another embodiment, a solar panel foundation system can incorporate the ground screw connection brackets to provide a complete foundation solution that can accommodate diverse installation environments and requirements. The system can include a first ground screw and a second ground screw, each having a shaft that can be disposed substantially parallel to the ground, with first and second ground screw connection brackets coupled to the respective shafts. A first member and a second member can be coupled to their respective ground screw connection brackets, with the members being disposed at an angle relative to the ground screws to create an angled configuration that can accommodate various installation requirements and terrain conditions. A mounting bracket can be configured to couple to and support a solar panel, with the first member and second member configured to support the mounting bracket, thereby providing a stable and adjustable foundation system that can maintain structural integrity while allowing for flexibility in positioning and load distribution.

In a further embodiment, a method of installing a solar panel foundation system can provide a streamlined installation process that reduces complexity and labor requirements compared to conventional welded connection systems. The method can include providing and positioning ground screws substantially parallel to the ground at predetermined locations, followed by providing ground screw connection brackets having the characteristic U-shaped configuration with closed ends and extending arms. Each bracket can be positioned around the shaft of its respective ground screw by inserting the shaft through the opening in the closed end, then secured by inserting and tightening clamping bolts through apertures in the proximal section of the arms to draw the arms together and cause the closed end to tighten around the shaft. The method can further include inserting set bolts through apertures in the closed end to provide additional securing means and coupling structural members to the brackets through connecting bolts, creating a complete foundation system that can provide the flexibility and adaptability disclosed in the provisional application.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a solar panel foundation system with a ground screw connection bracket according to the present disclosure;

FIG. 2 is an enlarged view of the ground screw connection bracket positioned on a ground screw;

FIG. 3 is a perspective view of the ground screw connection bracket;

FIG. 4 is another perspective view of the ground screw connection bracket;

FIG. 5 is a front elevational view of the ground screw connection bracket;

FIG. 6 is a rear elevational view of the ground screw connection bracket;

FIG. 7 is a top plan view of the ground screw connection bracket;

FIG. 8 is a side elevational view of the ground screw connection bracket;

FIG. 9 is another embodiment of the ground screw connection bracket positioned on a ground screw;

FIG. 10 is an enlarged perspective view of the ground screw connection bracket;

FIG. 11 is a perspective view of the ground screw connection bracket;

FIG. 12 is another perspective view of the ground screw connection bracket;

FIG. 13 is a front elevational view of the ground screw connection bracket;

FIG. 14 is a rear elevational view of the ground screw connection bracket;

FIG. 15 is a top plan view of the ground screw connection bracket;

FIG. 16 is a side elevational view of the ground screw connection bracket.

FIG. 17A-17B is a flow chart illustrating the method of installing a solar panel foundation system, showing the sequential steps from providing and positioning ground screws through completing the foundation system with the mounting bracket.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

All documents, including patents, patent applications, and scientific literature cited in this detailed description are incorporated herein by reference, unless otherwise expressly indicated. Where any conflict or ambiguity may exist between a document incorporated by reference and this detailed description, the present detailed description controls.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, all compositional percentages are by weight of the total composition, unless otherwise specified. Disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

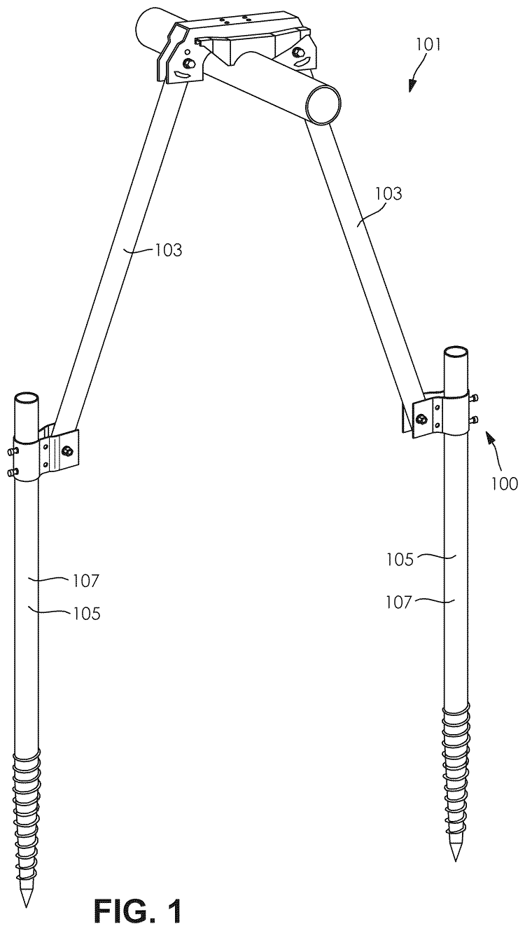

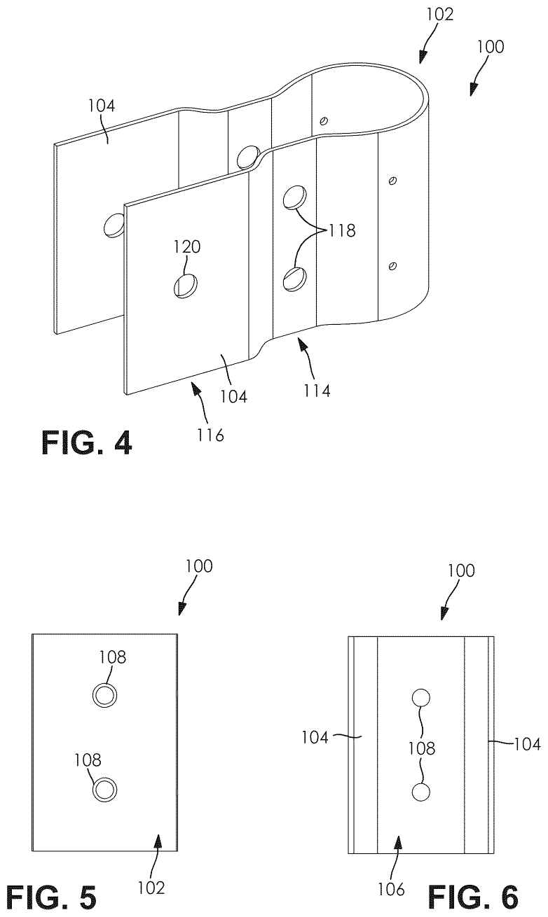

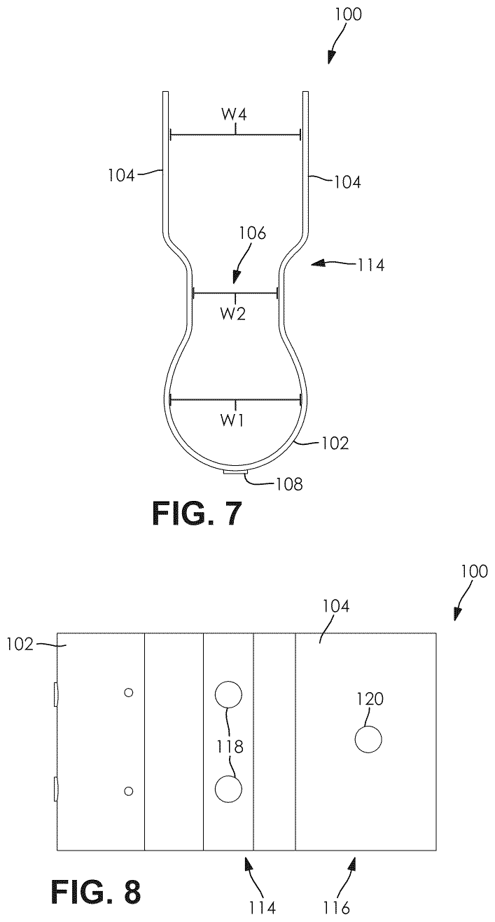

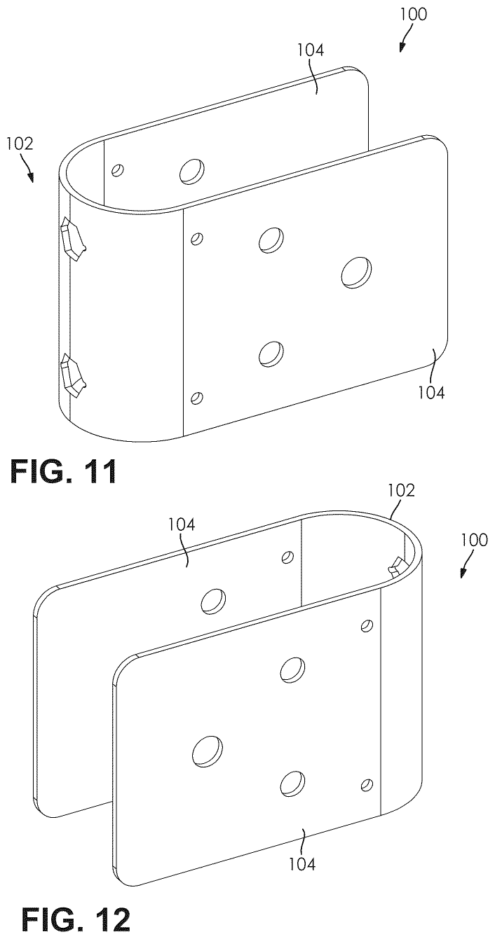

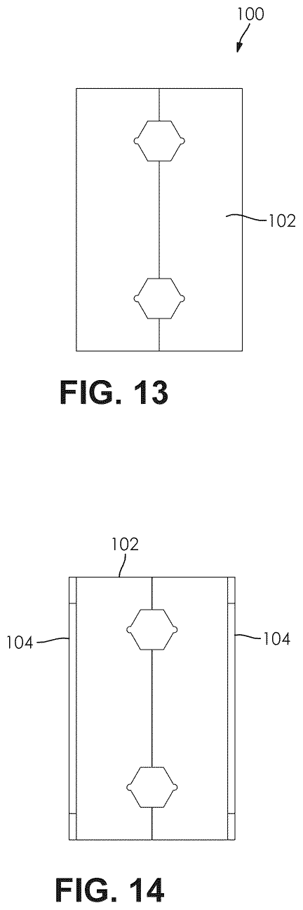

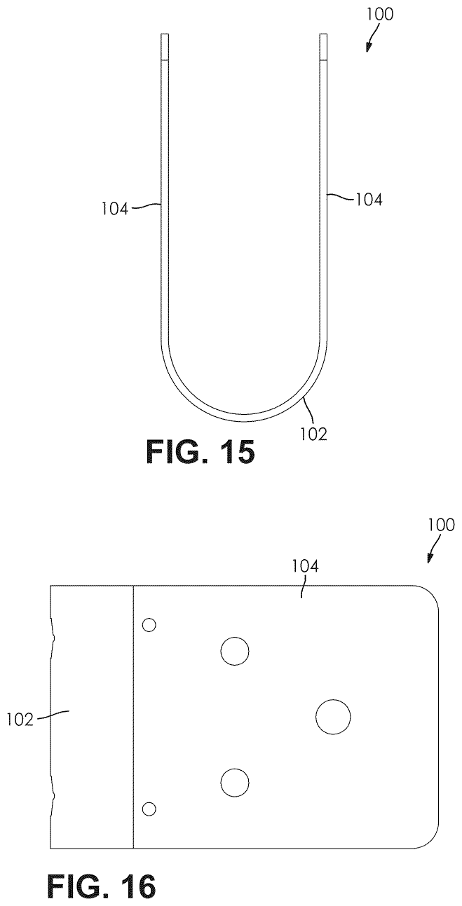

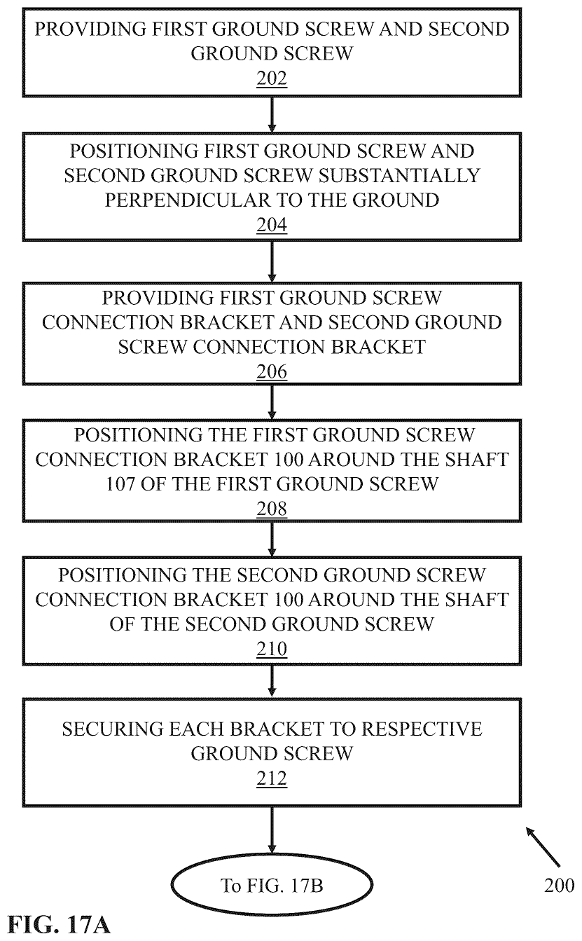

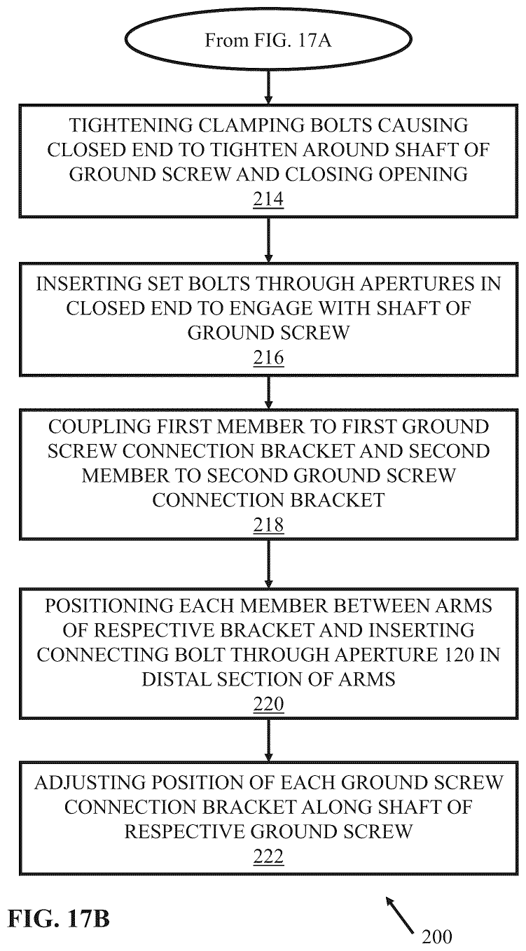

With reference to FIGS. 1-16, a ground screw connection bracket 100 for a solar panel is shown. The ground screw connection bracket 100 can be utilized with certain solar panel foundation systems 101. For example, reference is made to U.S. Patent Application Publication No. US 2023/0332368, published on Oct. 19, 2023, the entire disclosure of which is incorporated herein by reference. The referenced patent application describes a solar panel foundation system 101 that includes a bracket, braces, and members which can utilize the ground screw bracket detailed in this document. It should be appreciated that the ground screw connection bracket 100 of the present disclosure can be utilized within other solar panel foundation systems 101 within the scope of the present disclosure.

As shown in FIG. 1, the ground screw connection bracket 100 can be a specialized component configured for the solar panel foundation system 101 to provide a secure and adjustable connection between a structural member 103 and a ground screw 105. The bracket 100 can address the challenges of installing solar panels on sites with rough terrain, loose or frozen soil, or uneven topography by militating against the need for threaded connections welded to ground screws and can allow for flexible positioning along the shaft of the ground screw. The bracket 100 can connect directly to the outside of a shaft 107 of a ground screw 105 and can be adjusted up or down to accommodate diverse installation environments and requirements. The bracket 100 can be particularly beneficial for A-frame solar panel foundations, providing greater flexibility and adaptability while reducing the complexity of both installation and future modifications.

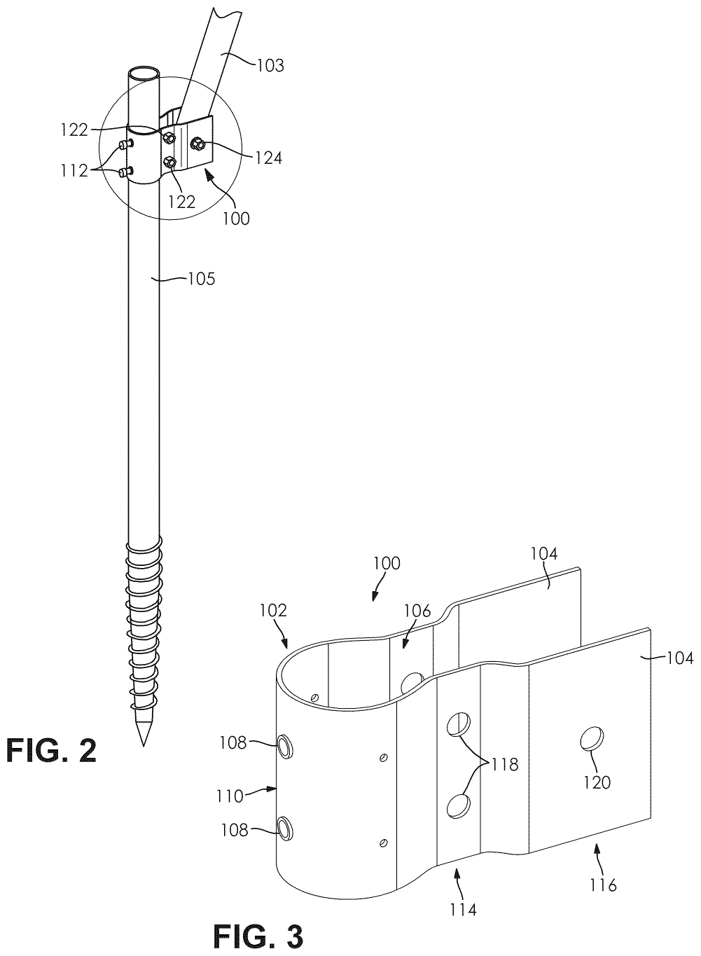

Referring now to FIGS. 2-8, the ground screw connection bracket 100 can be formed as a unitary body. The ground screw connection bracket 100 can be manufactured from a single piece of material using a stamping and bending and/or folding operation to create a generally U-shaped body. The stamping process can create a flat pattern with all necessary apertures, which can subsequently be bent and/or folded into the geometry of the ground screw connection bracket 100, as described herein. In an alternative embodiment, the ground screw connection bracket 100 can be formed from different pieces that 104 can be independently formed and subsequently coupled through various permanent connection means. The separate components can be joined through a welding process, such as MIG welding, TIG welding, or spot welding, for example, depending on the material selected and the structural requirements of the ground screw connection bracket 100. Other permanent connection means can include brazing, adhesive bonding with a structural adhesive, a mechanical fastening with rivets or bolts, or other metallurgical joining processes.

The ground screw connection bracket 100 can be constructed from a rust-proof material suitable for outdoor solar installation. The ground screw connection bracket 100 can be formed from stainless steel, which can provide corrosion resistance properties. Alternatively, the ground screw connection bracket 100 can be manufactured from aluminum alloy that can offer lightweight characteristics while maintaining durability. Galvanized steel can also serve as an effective material option, providing strength characteristics with enhanced corrosion protection. The ground screw connection bracket 100 can further include a weather-resistant coating, including a corrosion-proof coating such as powder coating, zinc plating, or other protective finishes that can create a barrier against environmental elements including moisture, salt air, and temperature fluctuations. A skilled artisan can select a suitable material for the ground screw connection bracket 100 within the scope of the present disclosure.

It should be appreciated that the ground screw connection bracket 100 can be constructed from a rigid material that can maintain structural integrity throughout the operational life of the ground screw connection bracket 100. While the forming process can involve controlled bending and/or folding to achieve the desired geometry, the ground screw connection bracket 100 can resist deformation during use. The rigidity can be advantageous given that the ground screw connection bracket 100 can be configured to receive the ground screw 105 of the solar panel foundation 101 without intermediate brackets or fasteners, requiring the ground screw connection bracket 100 to maintain alignment of the apertures and withstand operational loads imposed by the solar panel. The structural stability that can be provided by the rigid construction can facilitate reliable performance.

With continued reference to FIGS. 2-8, the ground screw connection bracket 100 can have a closed end 102 and a pair of arms 104 extending therefrom to define a generally U-shaped configuration. The closed end 102 can have a cross-sectional shape that can be selected to substantially match a cross-sectional shape of the shaft 107 of the ground screw 105 to facilitate a secure attachment of the bracket 100 to the ground screw 105. In one embodiment, the closed end 102 can have an arcuate cross-sectional shape that can be configured to conform to a cylindrical shaft 107 of the ground screw 105. The arcuate configuration can enable the closed end 102 to partially encircle the shaft 107, providing a contact surface that can distribute clamping forces uniformly around the circumference of a circular or cylindrical ground screw shaft. The radius of curvature of the arcuate cross-sectional shape can be determined based on the diameter of the shaft 107, with the arcuate shape being dimensioned to provide optimal contact area and force distribution for the specific ground screw configuration.

Alternatively, the closed end 102 can have other geometrical cross-sectional shapes such as triangular, square, or other multi-sided geometric shapes that can be selected to match corresponding cross-sectional shapes of the shaft 107 of the ground screw 105. The cross-sectional shape of the closed end 102 can be determined based on the specific geometry of the ground screw shaft 107 to ensure proper engagement and secure clamping functionality. This adaptability can enable the ground screw connection bracket 100 to accommodate various ground screw designs while maintaining the clamping force and adjustability features that provide greater flexibility and adaptability to accommodate diverse installation environments and requirements.

In the arcuate configuration, the closed end 102 can substantially encircle or wrap the shaft 107 of the ground screw 105, while the arms 104 can receive the structural member 103 of the solar panel foundation 101, thereby providing the connection between the structural member 103 and the ground screw 105. The arms 104 can be drawn together to create a clamping force that can cause the closed end 102 to tighten around the shaft 107 of the ground screw 105. As the arms 104 are brought together, the U-shaped configuration can facilitate the application of uniform clamping force around the circumference of the shaft 107 through the closed end 102. The clamping action can cause pressure to be exerted on the closed end 102, which can in turn apply uniform clamping force around the circumference of the shaft 107 of the ground screw 105. The U-shaped configuration can not only facilitate a strong and reliable connection but can also allow for easy adjustments and repositioning along the shaft 107, providing flexibility in the installation and maintenance of a solar panel foundation system 101. The ground screw connection bracket 100 can militate against the need for threaded connections welded to the ground screw, thereby reducing potential failure points and simplifying the overall installation process.

The closed end 102 can be generally circular in configuration but can include an opening 106 that can allow the ground screw connection bracket 100 to be received by an end of the shaft 107, slidingly positioned along a length of the shaft 107 to substantially encircle or wrap the shaft 107 at a desired location along the length of the the ground screw 105. The generally circular configuration can enable the closed end 102 to partially encircle the shaft 107, providing a contact surface that can conform to the cylindrical shape of the ground screw 105 for optimal force distribution. The closed end 102 can have a width (W1) that can be substantially the same as a width of the shaft 107 of the ground screw 105, enabling the bracket 100 to accommodate the ground screw 105 while maintaining proper clamping functionality around the shaft 107. The opening 106 can have a width (W2) that can be smaller than W1, but can be wide enough to allow the ground screw 105 to be positioned into the closed end 102 during installation.

The closed end 102 can further have a height that can be selected based on situational needs and structural requirements of the particular solar panel foundation system 101. The height of the closed end 102 can be disposed along a length of the ground screw 105, providing a contact area that can extend along the shaft 107. The height can be dimensioned to provide sufficient structural support to securely attach to the ground screw 105 and adequately support the weight of the structural member 103 and associated solar panel loads. The height dimension can be selected to ensure that the closed end 102 can maintain structural integrity under operational loads while facilitating an adjustable positioning of the ground screw connection bracket 100 along the shaft 107 of the ground screw 105.

The closed end 102 of the ground screw connection bracket 100 can include one or more apertures 108 formed therethrough. The apertures 106 in the closed end 102 can be positioned at an apex 110 of the curve of the closed end 102, providing a central attachment location that can facilitate connection to additional components of the solar panel foundation system. The apertures 108 in the closed end 102 can be configured to receive fasteners 112, such as set bolts, lag bolts, and self-taping bolts, as non-limiting examples, that can be configured to militate against relative movement between the ground screw connection bracket 100 and the ground screw 105 in operation. The positioning of apertures 106 at the apex 110 or center of the closed end 102 can provide optimal force distribution and can enable the bracket 100 to maintain secure engagement with the shaft 107 of the ground screw 105.

The apertures 108 in the closed end 102 can be arranged along a length of the closed end 102, with the number of apertures 108 determined based on the height of the closed end 102 and the load requirements of the particular installation. The apertures 108 can be aligned with a longitudinal axis of the ground screw 105 when the bracket 100 is positioned on the shaft 107, facilitating the insertion of fasteners 112 that can extend into or against the shaft 107. This arrangement can provide additional securing means beyond the clamping force applied by the arms 104, with the distribution of apertures 108 along the length of the closed end 102 enabling optimal load distribution based on the structural requirements of the solar panel foundation system 101. The apertures 108 can be sized and positioned to accommodate various fastener types while maintaining the structural integrity of the closed end 102. IT should also be understood that apertures can be provided at other locations around the closed end 102 to facilitate load distribution based on the structural requirements of the solar panel foundation system 101.

Having multiple apertures 108 distributed along the height of the closed end 102 can enhance the stability of the ground screw connection bracket 100 by providing multiple points of engagement with the shaft 107 of the ground screw 105. The distribution of apertures 108 along the height can create a more secure connection by spreading the securing forces over a greater length of the ground screw shaft 107, thereby reducing stress concentrations at any single point. Multiple apertures 108 can allow for the insertion of multiple set bolts at different elevations along the closed end 102, creating redundant securing points that can militate against movement of the ground screw 105 in operation. This multi-point engagement can provide enhanced resistance to rotational and axial forces that may be applied to the solar panel foundation system during operation, particularly under wind loads or other environmental stresses. The increased number of contact points along the height of the closed end 102 can also provide improved load distribution, enabling the ground screw connection bracket 100 to maintain structural integrity and secure engagement with the shaft 107 under varying operational conditions.

The set bolts can be serrated bolts that can include a serrated flange nut. The serrated bolts can be configured to engage with the shaft 107 of the ground screw 105 through the apertures 108 in the closed end 102. The serrated flange nut can facilitate an case of assembly and provide enhanced gripping capability against the shaft 107, with the serrations creating additional friction and resistance to movement. The serrated configuration can militate against movement of the ground screw 105 in operation by creating multiple contact points that can resist rotational and axial forces. The serrated flange nut can distribute the clamping force over a larger surface area while the serrations can bite into the surface of the shaft 107, providing additional securing means beyond the clamping force applied by the arms 104.

The pair of arms 104 can extend from opposing sides of the opening 106 in the closed end 102, creating the U-shaped configuration of the ground screw connection bracket 100. The arms 104 can be arranged substantially perpendicular to the height of the closed end 102, enabling the arms 104 to project outwardly from the closed end 102 in a manner that can facilitate engagement with the member 103 of the solar panel foundation 101. This perpendicular arrangement can ensure that the arms 104 can maintain proper alignment and structural integrity when receiving and securing the structural member 103.

Each of the arms 104 can have a taper such that a width (W3) between the arms 104 at a first portion 114 proximal to the opening 106 can be smaller than a width (W4) between the arms 104 at a distal portion 116 to the opening 106. The tapered configuration can provide structural advantages by creating a narrower profile near the closed end 102 while expanding to a wider configuration at the distal ends of the arms 104. This tapering can facilitate the insertion and positioning of the structural member 103 of the solar panel foundation system 101 between the arms 104, as the wider distal portion can provide increased clearance for accommodating various sizes and configurations of structural members. The tapered configuration can also optimize the force distribution along the length of the arms 104, with the narrower proximal portion 114 providing concentrated force transmission to the closed end 102 while the wider distal portion 116 can distribute loads more effectively across the connection interface with the structural member 103. The taper can enhance the structural efficiency of the ground screw connection bracket 100 by providing variable cross-sectional properties that can be optimized for the different functional requirements along the length of each arm 104.

Each of the arms 104 can include a plurality of apertures formed therethrough that can align with corresponding apertures on the opposing arm 104. The plurality of apertures can include one or more apertures 118 in the proximal section 114 and one or more apertures 120 in the distal portion 116 of each arm 104. The apertures 118 and 120 can be aligned across the respective width (W3, W4) between the arms 104, allowing a fastener to pass from one arm 104 to the other arm 104. This alignment can facilitate the insertion of fasteners that can pass through both arms 104 simultaneously, enabling the arms 104 to be drawn together to create the clamping action around the ground screw 105 and/or the structural members 103.

The one or more apertures 118 can be arranged along a height of the proximal section 114 of the arm 104, with the number of apertures 118 selected based on the height of the arm 104. The fasteners 122 can be a serrated bolt and serrated flange nut as non-limiting examples, providing enhanced gripping capability for the clamping mechanism. In some embodiments, the serrated nut can be co-formed with one of the arms 104, creating an integrated fastening system that can reduce the number of separate components required for assembly. The fasteners 122 can provide the clamping force and can generally pull the closed end 102 inward, closing the opening 106 around the shaft 107 of the ground screw 105. The serrated configuration of the fasteners 122 can create multiple contact points that can resist loosening under operational loads, while the inward pulling action can cause the closed end 102 to tighten securely around the ground screw shaft. The arrangement of multiple apertures 118 along the height of the arm 104 can distribute the clamping forces more evenly and can provide redundant securing points that can enhance the overall stability of the connection.

The aperture 120 disposed within the distal section 116 of the arm 104 can be configured to receive a bolt 124 that provides sufficient clamping force to secure the member 103 in position while operating independently of the clamping mechanism that secures the ground screw connection bracket 100 to the shaft 107 of the ground screw 105. The bolt 124 can serve as a pivot point for the member 103, allowing for the angle of the member 103 to be adjusted relative to the ground screw 105. This pivoting capability can provide additional flexibility in the installation and positioning of the solar panel foundation system 101 by enabling angular adjustments of the structural member 103 without requiring repositioning of the ground screw connection bracket 100 along the shaft 107. The pivot function can accommodate variations in terrain or installation requirements while maintaining the secure clamping connection between the closed end 102 and the ground screw 105.

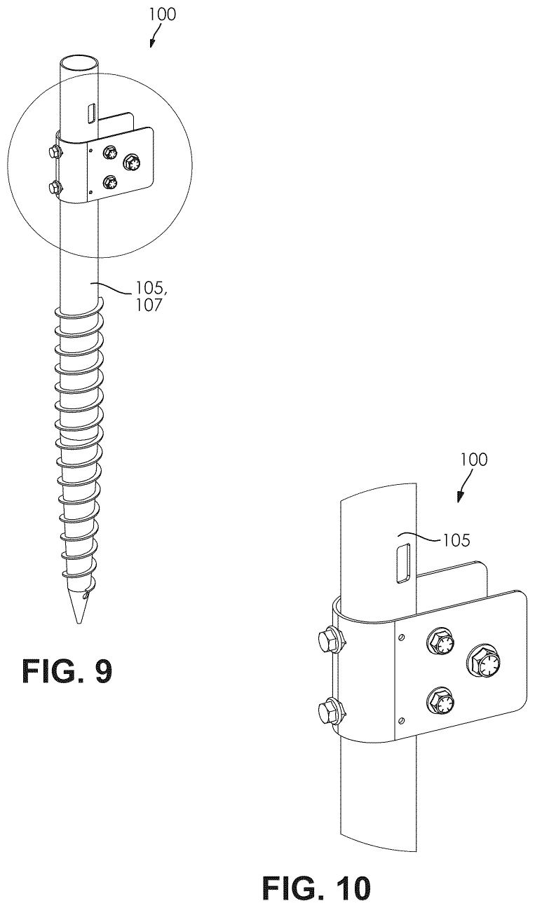

With reference to FIGS. 9-16, in an alternative embodiment, the ground screw connection bracket 100 can include an closed end 102 and a pair of arms 104 extending therefrom to define a generally U-shaped configuration, wherein the arms 104 maintain a substantially uniform width from the proximal section 114 to the distal section 116. Unlike the tapered configuration described previously, this embodiment can provide arms 104 that have a consistent width throughout their length, creating a more uniform structural profile. The uniform width configuration can provide consistent cross-sectional properties along the entire length of each arm 104, which can be advantageous in applications where uniform load distribution and consistent structural characteristics are desired. The arms 104 can still include the plurality of apertures 118 in the proximal section 114 and apertures 120 in the distal section 116, with the apertures being aligned across the consistent width between the arms 104 to allow fasteners to pass from one arm 104 to the other. This uniform width embodiment can maintain the same clamping functionality and adjustability features while providing an alternative structural configuration that may be preferred for certain installation requirements or manufacturing considerations.

With reference to FIG. 1., the solar panel foundation system 101 can include a first ground screw 105 and a second ground screw 105, each having a shaft 107 that can be disposed substantially perpendicular to the ground. The system 101 can further include a first ground screw connection bracket 100 and a second ground screw connection bracket 100, where each ground screw connection bracket 100 can have an closed end 102 and a pair of arms 104 extending therefrom to define a generally U-shaped configuration. The first ground screw connection bracket 100 can be coupled to the shaft of the first ground screw 105, and the second ground screw connection bracket 100 can be coupled to the shaft of the second ground screw 105.

The system 101 can include a first structural member 103 and a second member 103, where the first member 103 can be coupled to the first ground screw connection bracket 100 and the second member 103 can be coupled to the second ground screw connection bracket 100. The connection between each member 103 and its respective bracket 100 can be facilitated through the fasteners that can pass through the apertures 118 in the proximal section 114 of the arms 104. The fasteners can include the clamping bolts 122 that can pass through the apertures 118 in the proximal section 114 and receive a nut to allow the bolt 122 to be tightened against the respective ground screw connection bracket 100, providing the clamping force that can pull the closed end 102 inward and close the opening 106 around the shaft 107 of the respective ground screw 105.

Each bracket 100 can further include the connecting bolt 124 that can pass through the aperture 120 in the distal section 116 of the arms 104 and receive a nut to allow the bolt 124 to be tightened against the respective ground screw connection bracket 100 and the structural member 103. The connecting bolt 124 can serve as the pivot point for the member 103, allowing for angular adjustment of the member 103 relative to the ground screw 105 while providing sufficient clamping force to secure the member 103 in position. The first member 103 and the second member 103 can be disposed at an angle relative to the ground screws 105, creating the angled configuration that can accommodate various installation requirements and terrain conditions.

The closed end 102 of each bracket 100 can include the set bolts that can be inserted through the apertures 108 formed in the closed end 102. The set bolts can be the serrated bolts with the serrated flange nuts that can engage with the shaft of the ground screw 105, providing additional securing means that can militate against movement of the ground screw 105 in operation. The first member 103 and the second member 103 can be configured to support the mounting bracket for the solar panel, with the various fasteners ensuring secure connections throughout the foundation system 101.

A method 200 of installing a solar panel foundation system 101 can include a step 202 of providing a first ground screw 105 and a second ground screw 105, each having a shaft 107. The method 200 can include a step 204 of positioning the first ground screw 105 and the second ground screw 105 substantially perpendicular to the ground at predetermined locations based on the installation requirements and terrain conditions.

The method 200 can include a step 206 of providing a first ground screw connection bracket 100 and a second ground screw connection bracket 100, where each bracket 100 can have a closed end 102 and a pair of arms 104 extending therefrom to define a generally U-shaped configuration. The method 200 can include a step 208 of positioning the first ground screw connection bracket 100 around the shaft 107 of the first ground screw 105 by inserting the shaft through the opening 106 in the closed end 102. The method 200 can include a step 210 of positioning the second ground screw connection bracket 100 around the shaft of the second ground screw 105.

The method 200 can include a step 212 of securing each bracket 100 to its respective ground screw 105 by inserting the clamping bolts 122 through the apertures 118 in the proximal section 114 of the arms 104. The method 200 can include a step 214 of tightening the clamping bolts 122 to draw the arms 104 together, causing the closed end 102 to tighten around the shaft of the ground screw 105 and closing the opening 106. The method 200 can include a step 216 of inserting the set bolts through the apertures 108 in the closed end 102 to engage with the shaft of the ground screw 105, providing additional securing means that can militate against movement of the ground screw 105 in operation.

The method 200 can include a step 218 of coupling a first member 103 to the first ground screw connection bracket 100 and a second member 103 to the second ground screw connection bracket 100. The method 200 can include a step 220 of positioning each member 103 between the arms 104 of its respective bracket 100 and inserting the connecting bolt 124 through the aperture 120 in the distal section 116 of the arms 104. The method 200 can include a step 222 of adjusting the position of each ground screw connection bracket 100 along the shaft of its respective ground screw 105 to achieve the desired height and alignment for the solar panel foundation system 101. The method 200 can include a step of coupling the mounting bracket to the first member 103 and the second member 103, where the mounting bracket can be configured to support the solar panel.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A ground screw connection bracket comprising:
A closed end having with an opening, the closed end configured to partially surround a shaft of a ground screw; and
a pair of arms extending from opposing sides of the opening in the closed end, each arm including a plurality of apertures formed therethrough that are configured to align with corresponding apertures on an opposing arm, wherein the arms are selectively movable to be drawn together to create a clamping force that causes the closed end to tighten around the shaft of the ground screw.

2. The ground screw connection bracket of claim 1, wherein the closed end includes one or more apertures formed therethrough that are configured to receive fasteners that militate against movement of the ground screw in operation.

3. The ground screw connection bracket of claim 2, wherein the apertures in the closed end are arranged along a length of the closed end, with a number of apertures determined based on a height of the closed end and load requirements of a particular installation.

4. The ground screw connection bracket of claim 2, wherein the fasteners comprise set bolts that are serrated bolts including a serrated flange nut.

5. The ground screw connection bracket of claim 1, wherein the closed end has a width that is substantially the same as a width of the ground screw, and the opening has a width that is smaller than the width of the closed end but wide enough to allow the ground screw to be positioned into the closed end during installation.

6. The ground screw connection bracket of claim 1, wherein the closed end has a height that is selected based on situational needs and structural requirements, the height being disposed along a length of the ground screw to provide sufficient structural support to securely attach to the ground screw.

7. The ground screw connection bracket of claim 1, wherein each arm has a taper such that a width between the arms at a first portion proximal to the opening is smaller than a width between the arms at a second portion distal to the opening.

8. The ground screw connection bracket of claim 1, wherein the plurality of apertures in each arm includes one or more apertures in a proximal section and one or more apertures in a distal portion, the apertures being aligned across a respective width between the arms to allow a fastener to pass from one arm to another arm.

9. The ground screw connection bracket of claim 8, wherein the apertures in the proximal section are configured to receive clamping bolts that provide the clamping force and pull the closed end inward, closing the opening around the shaft of the ground screw.

10. The ground screw connection bracket of claim 9, wherein the clamping bolts comprise serrated bolts with serrated flange nuts.

11. The ground screw connection bracket of claim 8, wherein an aperture in the distal portion is configured to receive a connecting bolt that serves as a pivot point for a structural member while operating independently of a clamping mechanism that secures the ground screw connection bracket to the shaft of the ground screw.

12. The ground screw connection bracket of claim 1, wherein the arms are arranged substantially perpendicular to a height of the closed end.

13. The ground screw connection bracket of claim 1, wherein multiple apertures distributed along a height of the closed end enhance stability by providing multiple points of engagement with the shaft of the ground screw.

14. The ground screw connection bracket of claim 1, wherein the ground screw connection bracket is constructed from a rust-proof material suitable for outdoor solar installation.

15. The ground screw connection bracket of claim 14, wherein the rust-proof material is selected from the group consisting of stainless steel, aluminum alloy, and galvanized steel.

16. A solar panel foundation system comprising:
a first ground screw and a second ground screw, each having a shaft disposed substantially parallel to ground;
a first ground screw connection bracket and a second ground screw connection bracket according to claim 1, wherein the first ground screw connection bracket is coupled to the shaft of the first ground screw and the second ground screw connection bracket is coupled to the shaft of the second ground screw;
a first member and a second member, wherein the first member is coupled to the first ground screw connection bracket and the second member is coupled to the second ground screw connection bracket, the first member and second member being disposed at an angle relative to the ground screws; and
a mounting bracket configured to couple to and support a solar panel, wherein the first member and second member are configured to support the mounting bracket.

17. The solar panel foundation system of claim 16, wherein each ground screw connection bracket includes:
clamping bolts that pass through apertures in a proximal section of the arms to provide clamping force that pulls the closed end inward and closes the opening around the shaft of the respective ground screw;
a connecting bolt that passes through an aperture in a distal section of the arms and serves as a pivot point for the respective member; and
set bolts inserted through apertures in the closed end to engage with the shaft of the ground screw and militate against movement of the ground screw in operation.

18. The solar panel foundation system of claim 17, wherein the set bolts are serrated bolts with serrated flange nuts that provide enhanced gripping capability against the shaft.

19. The solar panel foundation system of claim 16, wherein each ground screw connection bracket is adjustably positionable along the shaft of its respective ground screw to adjust a height of the solar panel disposed on the foundation system.

20. A method of installing a solar panel foundation system comprising:
providing a first ground screw and a second ground screw, each having a shaft, and positioning the ground screws substantially parallel to ground at predetermined locations;
providing a first ground screw connection bracket and a second ground screw connection bracket, each having an closed end with a generally circular configuration and an opening, and a pair of arms extending from opposing sides of the opening to define a generally U-shaped configuration;
positioning each ground screw connection bracket around the shaft of its respective ground screw by inserting the shaft through the opening in the closed end;
securing each bracket to its respective ground screw by inserting clamping bolts through apertures in a proximal section of the arms and tightening the clamping bolts to draw the arms together, causing the closed end to tighten around the shaft and close the opening;
inserting set bolts through apertures in the closed end to engage with the shaft of the ground screw and militate against movement of the ground screw in operation; and
coupling a first member and a second member to their respective brackets by positioning each member between the arms and inserting a connecting bolt through an aperture in a distal section of the arms.
